(19) United States
(12) Patent Application Publication
(10) Pub. No.: US 2015/0072129 A1
(43) Pub. Date: Mar. 12, 2015

(54) GLASS SHEET CAPABLE OF BEING INHIBITED FROM WARPING THROUGH CHEMICAL STRENGTHENING

(71) Applicant: ASAHI GLASS COMPANY, LIMITED, Chiyoda-ku (JP)

(72) Inventors: Naoki OKAHATA, Tokyo (JP); Koji NAKAGAWA, Tokyo (JP); Kazuhiko YAMANAKA, Tokyo (JP); Kunio WATANABE, Tokyo (JP); Shiro TANII, Tokyo (JP); Nobuaki IKAWA, Tokyo (JP); Daisuke KOBAYASHI, Tokyo (JP); Junichi MIYASHITA, Tokyo (JP); Ryosuke KATO, Tokyo (JP); Toshifumi NIHEI, Tokyo (JP); Yoichi SERA, Tokyo (JP); Yasuo HAYASHI, Tokyo (JP); Makoto FUKAWA, Tokyo (JP)

(73) Assignee: ASAHI GLASS COMPANY, LIMITED, Chiyoda-ku (JP)

(21) Appl. No.: 14/498,120

(22) Filed: Sep. 26, 2014

Related U.S. Application Data
(63) Continuation of application No. PCT/JP2013/057724, filed on Mar. 18, 2013.

(30) Foreign Application Priority Data
Mar. 20, 2012 (JP) 2012-081072
Mar. 26, 2012 (JP) 2012-069557
Mar. 29, 2012 (JP) 2012-078171
Mar. 30, 2012 (JP) 2012-081073
Dec. 19, 2012 (JP) 2012-276840

(51) Int. Cl. C03C 21/00; C03C 15/00

(52) U.S. Cl. CPC C03C 21/002; C03C 15/00
USPC 428/220; 428/409; 428/410

(57) ABSTRACT

A glass sheet includes 4 mol % or more of Al₂O₃. In the glass sheet, a surface Na₂O amount in one surface of the glass sheet is lower than the surface Na₂O amount in the other surface of the glass sheet by 0.2 mass % to 1.2 mass %.

### TECHNICAL FIELD

The present invention relates to a glass sheet capable of reducing warpage during chemical strengthening.

### BACKGROUND ART

In recent years, in a flat panel display device, such as a mobile phone or a personal digital assistant (PDA), in order to enhance protection and beauty of a display, a thin sheet-shaped cover glass is arranged on a front surface of a display so as to cover a region wider than an image display area.

Reduction in weight and thickness is required for this kind of flat panel display device, and to meet the requirement, reduction in thickness is also required for a cover glass for display protection.

However, when the thickness of the cover glass is reduced, strength thereof is lowered, and the cover glass itself may break during use or due to drop thereof during carrying. Accordingly, there is a problem in that the primary role of protecting a display device cannot be performed.

For this reason, in the cover glass of the related art, in order to improve scratch resistance, a float glass produced by a float method is chemically strengthened to form a compressive stress layer in the surface thereof, thereby enhancing scratch resistance of the cover glass.

It has been reported that warpage occurs in a float glass after chemical strengthening, causing deterioration of flatness (Patent Documents 1 to 3). The warpage occurs due to the difference in the degree of behavior of chemical strengthening between a glass surface (hereinafter, referred to as a top surface) which is not in contact with molten tin during float forming and a glass surface (hereinafter, referred to as a bottom surface) which is in contact with molten tin.

The warpage of a float glass becomes large with an increase in the degree of behavior of chemical strengthening. Accordingly, in a chemically strengthened float glass having surface compressive stress of 600 MPa or more and a depth of a compressive stress layer of 15 μm or more, which has been developed to response to the requirement of high scratch resistance, the problem of warpage becomes obvious compared to a chemically strengthened float glass of the related art having surface compressive stress (CS) of about 500 MPa and a depth of a compressive stress layer (DOL) of about 10 μm.

Patent Document 1 discloses a glass strengthening method in which, after a SiO₂ film is formed on a glass surface, chemical strengthening is performed to adjust the amount of ions which diffuse into glass during chemical strengthening. Patent Documents 2 and 3 disclose a method in which surface compressive stress on a top surface side is set within a specific range, thereby reducing warpage after chemical strengthening.

In the related art, in order to reduce the problem of warpage, a coping method of decreasing strengthening stress by chemical strengthening, or removing a surface heterogeneous layer through grinding treatment or polishing treatment on at least one surface of the glass, and then performing chemical strengthening, has been carried out.

### CITATION LIST

### Patent Documents

Patent Document 1: US 2011/0293928 A1
Patent Document 2: WO 2007/004634 A1
Patent Document 3: JP S62-191449 A

### SUMMARY OF INVENTION

### Technical Problem

However, in the method described in Patent Document 1 in which chemical strengthening is performed after the SiO₂ film is formed on the glass surface, preheating conditions during chemical strengthening are limited, and the film quality of the SiO₂ film may change depending on the conditions to affect warpage. As described in Patent Documents 2 and 3, the method in which surface compressive stress on the top surface side is set within the specific range has a problem from the viewpoint of strength of glass.

The method in which at least one surface of glass is subjected to grinding treatment or polishing treatment before chemical strengthening has a problem from the viewpoint of improvement of productivity, and it is preferable to omit the grinding treatment, polishing treatment or the like.

When warpage occurs to a certain degree or more after chemical strengthening, the gap between glass and a stage becomes too large when a black frame is printed on a cover glass, and glass may not be adsorbed to the stage. In a case of a touch panel integrated cover glass, ITO (Indium Tin Oxide) or the like may be formed in a state of a large substrate in a subsequent process. At this time, failure may occur. For example, conveyance abnormality, such as contact with an air knife of a chemical processing tank or cleaning tank, may occur, warpage may increase during ITO film formation, the film forming state of ITO in a peripheral portion of a substrate may not be appropriate, or the ITO film may be separated. In a case of a type in which a space is present between an LCD (Liquid Crystal Display) and a cover glass to which a touch panel has been attached, when warpage occurs in the cover glass to a certain degree or more, luminance irregularity or Newton rings may occur.

Accordingly, an object of the present invention is to provide a glass sheet by which warpage after chemical strengthening can be effectively suppressed and polishing treatment or the like before chemical strengthening can be omitted or simplified.

### Solution to Problem

1. A glass sheet, comprising 4 mol % or more of Al₂O₃, wherein a surface Na₂O amount in one surface thereof is lower than the surface Na₂O amount in the other surface thereof by 0.2 mass % to 1.2 mass %.

2. A glass sheet, which does not comprise CaO or comprises 6 mol % or less of CaO, wherein a surface Na₂O amount in one surface thereof is lower than the surface Na₂O amount in the other surface thereof by 0.2 mass % to 1.2 mass %.

3. A glass sheet, comprising 3 mol % or more of K₂O, wherein a surface Na₂O amount in one surface thereof is lower than the surface Na₂O amount in the other surface thereof by 0.2 mass % to 1.2 mass %.

4. The glass sheet according to any one of the above items 1 to 3, wherein the surface Na₂O amount in the one surface is lower than the surface Na₂O amount in the other surface by 0.7 mass %.

5. The glass sheet according to any one of the above items 1 to 4, which is manufactured by a float method.

6. The glass sheet according to any one of the above items 1 to 5, wherein the surface having the smaller surface Na₂O amount is a surface which has not been in contact with molten metal in a float bath.

7. The glass sheet according to any one of the above items 1 to 6, wherein in the surface having the smaller surface Na₂O amount, a layer having an amount of Na₂O lower than the amount of Na₂O inside the glass sheet has a thickness of less than 5 μm.

8. The glass sheet according to any one of the above items 1 to 7, which has a thickness of 1.5 mm or less.

9. The glass sheet according to any one of the above items 1 to 8, which has a thickness of 0.8 mm or less.

10. A glass sheet, which is obtained by chemically strengthening the glass sheet according to any one of the above items 1 to 9.

11. A chemically strengthened glass sheet, wherein a surface Na₂O amount in one surface thereof is lower than the surface Na₂O amount in the other surface thereof by 0.2 mass % to 1.2 mass %.

12. The chemically strengthened glass sheet according to the above item 11, wherein in the surface having the smaller surface Na₂O amount, a layer having an amount of Na₂O lower than the amount of Na₂O inside the glass sheet has a thickness of less than 5 μm.

13. The chemically strengthened glass sheet according to the above item 11 or 12, which has a thickness of 1.5 mm or less.

14. The chemically strengthened glass sheet according to any one of the above items 11 to 13, which has a thickness of 0.8 mm or less.

15. A flat panel display device, comprising a cover glass, wherein the cover glass is the chemically strengthened glass sheet according to any one of the above items 11 to 14.

### Advantageous Effects of Invention

According to the glass sheet of the present invention, the surface thereof has been subjected to dealkalization treatment, the occurrence of the difference in the degree of behavior of chemical strengthening between one surface and the other surface of glass is suppressed, and stress by the chemical strengthening is not lowered.

When the glass sheet in the present invention is float glass, according to the preferred embodiments of the present invention, it is possible to obtain the glass sheet without the recesses that prevent the glass sheet from being used as cover glass.

### BRIEF DESCRIPTION OF DRAWINGS

FIG. 1 is a diagram schematically showing a double-flow type injector which can be used in the present invention.

FIG. 2 is a diagram schematically showing a single-flow type injector which can be used in the present invention.

FIG. 3 is a sectional view of a flat panel display in which a float glass for chemical strengthening of the present invention having been subjected to chemical strengthening is used as a cover glass for a flat panel display.

FIG. 4 is a perspective view of a test apparatus used in Examples (Example 1).

FIG. 5 is a view illustrating a relationship of a difference (mass %; ΔNa₂O) between surface Na₂O amounts in one surface and surface Na₂O amounts in the other surfaces, measured by an XRF analysis, and Δ warpage amount of a chemically strengthened glass sheet (Example 1).

FIG. 6 is a schematic view of a method of supplying gas capable of ion exchange reaction with alkaline components in glass, to the glass sheet via an introduction tube.

FIG. 7A is a schematic explanatory view of a method of supplying gas containing molecules having fluorine atoms in the structure thereof by a beam to process a surface of glass ribbon in the manufacture of a glass sheet by a float method.

FIG. 7B is a sectional view taken along the line A-A of FIG. 7A.

FIGS. 8A-8D are sectional views of a beam which can adjust the amount of gas into three systems in a width direction of glass ribbon.

### DESCRIPTION OF EMBODIMENTS

1. Glass Sheet

Warpage of the glass sheet after chemical strengthening occurs due to the difference in the degree of behavior of chemical strengthening between one surface and the other surface of the glass sheet. Specifically, for example, in a case of float glass, warpage after chemical strengthening occurs due to the difference in the degree of behavior of chemical strengthening between a glass surface (top surface) which is not in contact with molten tin during float forming and a glass surface (bottom surface) which is in contact with molten metal (usually, tin).

According to the present invention, the glass sheet is subjected to a dealkalization treatment, and the difference between the degree of dealkalization between in one surface thereof and that in the other surface thereof is set to be within a specific range, and as a result, it is possible to control a diffusion velocity of ions in the one surface and in the other surface of the glass sheet, and it is possible to achieve a balance in the degree of behavior of chemical strengthening between the one surface and the other surface. For this reason, in the glass sheet of the present invention, it is possible to reduce the warpage of the chemically strengthened glass sheet without controlling strengthening stress, or without conducting grinding treatment or polishing treatment before chemical strengthening treatment.

In the dealkalization phenomena of the surface of the glass containing Na as an alkali component, the following three steps (a), (b), and (c) are sequentially repeated:

(a) transportation of the alkali component from an inner portion of the glass to the surface of the glass (an exchange reaction between Na⁺ and H⁺ inside the glass);

(b) an exchange reaction between Na⁺ and H⁺ on the surface of the glass; and

(c) removal of Na⁺, which was exchanged with H⁺, from the surface of the glass.

It is possible to evaluate the degree of dealkalization of the surface of the glass by measuring the amount of Na₂O. In the present invention, the amount of Na₂O in the glass is evaluated by an X-ray fluorescence (XRF) spectrometer using Na—Kα rays.

The analysis conditions of the XRF (X-ray fluorescence analysis) are as follows. The amount of Na₂O is determined by using a calibration curve method and a reference sample of Na₂O. As the measurement apparatus, ZSX100 manufactured by Rigaku Corporation is exemplified.

Output: Rh 50 kV-72 mA

Filter: OUT

Attenuator: 1/1

Slit: Std.

Analyzing crystal: RX25

Detector: PC

Peak angle (2θ/deg.): 47.05

Peak measurement time period (seconds): 40

B. G. 1 (2θ/deg.): 43.00

B. G. 1 measurement time period (seconds): 20

B. G. 2 (20/deg.): 50.00

B. G. 2 measurement time period (seconds): 20

PHA: 110-450

In the glass sheet of the present invention, the surface Na₂O amount in one surface is lower than the surface Na₂O amount in the other surface by 0.2 mass % to 1.2 mass %, preferably 0.3 mass % to 0.7 mass %. When the glass sheet of the present invention has the surface Na₂O amount in these surfaces within this range, the warpage caused during chemical strengthening is reduced.

When the surface Na₂O amount in the one surface thereof is lower than the surface Na₂O amount in the other surface thereof, and the difference therebetween (hereinafter, the difference may be referred to as ΔNa₂O amount) is less than 0.2 mass %, the effect of reduction of the warpage is small. The ΔNa₂O amount is preferably 0.3 mass % or more.

Generally, the glass sheet manufactured by a float method (hereinafter, may be referred to as float glass) warps toward the top surface by approximately 30 μm. Accordingly, when the ΔNa₂O amount exceeds 1.2 mass %, the reduction of the warpage becomes excessive, and the glass sheet may considerably warp toward the side opposite to the top surface.

When the glass sheet is float glass, and the ΔNa₂O amount exceeds 0.7 mass %, the surface of the glass sheet may be likely to have recesses that prevent the glass sheet from being used as cover glass. Accordingly, when the glass surface is required to have no recess, the ΔNa₂O amount is preferably 0.7 mass % or less, more preferably 0.5 mass % or less, and particularly preferably 0.31 mass % or less.

The recesses described herein are recesses which can be recognized when the surface of the glass sheet is observed by using a scanning electron microscope (SEM) at a magnification of 50,000 to 200,000. Typically, the recess has a diameter equal to or more than 10 nm to 20 nm, and a diameter of 40 nm or less. The recess has a depth equal to or more than 5 nm to 10 nm. With respect to the case where the glass sheet is prevented from being used as the cover glass due to the occurrence of the recesses, it indicates that a density of the recesses on the surface is 7 recesses/μm² or more. Accordingly, even though the recesses exist on the surface, the density thereof is preferably 6 recesses/μm² or less. When the density of the recess is 6 recesses/μm², an average distance between the recesses is 460 nm.

In the glass sheet manufactured by the float method, the surface Na₂O amount in the top surface is preferably lower than the surface Na₂O amount in the other surface thereof, that is, the bottom surface.

In the surface having the smaller surface Na₂O amount, a layer having an amount of Na₂O lower than the amount of Na₂O inside the glass sheet (the amount of Na₂O inside the glass sheet, which does not change in a depth direction of the glass sheet, or the amount of Na₂O at a center portion of the glass sheet in the thickness direction of the glass sheet) preferably has a thickness of less than 5 μm. For example, in the surface having the smaller surface Na₂O amount, if the layer having an amount of Na₂O lower than the amount of Na₂O inside the glass sheet preferably is set to have a thickness of less than 5 μm, a dealkalization treatment temperature can be prevented from excessively increasing.

In this specification, the one surface and the other surface of the glass sheet indicate one surface and the other surface, respectively, which face each other in the thickness direction. Both surfaces of the glass sheet indicate both surfaces facing each other in the thickness direction.

2. Method of Manufacturing Glass Sheet

A method of forming a glass sheet having a sheet shape from molten glass in the present invention is not particularly limited, and a glass sheet having various compositions may be used insofar as the glass sheet has a composition capable of being strengthened by chemical strengthening treatment. For example, various raw materials are compounded with appropriate amounts, heated and molten, followed by homogenizing by defoaming, stirring, or the like, and it is formed in a sheet shape by a known float method, a down-draw method (for example, a fusion method or the like), a press method or the like, and after annealing, the sheet is cut to a desired size, followed by subjecting to polishing. Thus, a glass sheet is manufactured. Of these manufacturing methods, in particular, glass manufactured by a float method is preferable since warpage improvement after chemical strengthening, which is the effect of the present invention, is easily exhibited.

As the glass sheet which is used in the present invention, specifically, for example, a glass sheet formed of soda-lime silicate glass, aluminosilicate glass, borate glass, lithium aluminosilicate glass, borosilicate glass, alkali-free glass or various kinds of the others is typically exemplified.

Of these, glass having a composition containing Al is preferable. If alkali coexists, Al is tetracoordinated, and similarly to Si, participates in forming a network of glass. If tetracoordinated Al increases, movement of alkali ions is facilitated, and ion exchange easily proceeds during chemical strengthening treatment.

The thickness of the glass sheet is not particularly limited, and for example, is 2 mm, 0.8 mm, 0.73 mm, and 0.7 mm. In order to effectively perform chemical strengthening treatment described below, the thickness of the glass sheet is usually preferably 5 mm or less, more preferably 3 mm or less, more preferably 1.5 mm or less, and particularly preferably 0.8 mm or less.

Usually, the warpage amount of a glass sheet having a thickness of 0.7 mm after chemical strengthening is required to be 40 μm or less. When CS is 750 MPa and DOL is 40 μm in a 90 mm square glass sheet, the warpage amount after chemical strengthening is about 130 μm. On the other hand, since the warpage amount of the glass sheet after chemical strengthening is inversely proportional to the square of the sheet thickness, the warpage amount when the thickness of the glass sheet is 2.0 mm becomes about 16 μm, and warpage will not substantially become a problem. Accordingly, there is a possibility that the problem of warpage after chemical strengthening is likely to occur when the thickness of the glass sheet is less than 2 mm, and typically, is 1.5 mm or less.

The composition of the glass sheet of the present invention is not particularly limited, and for example, the following glass composition is exemplified. For example, the description of “0 to 25% of MgO is contained”, means that MgO is not essential and may be contained up to 25%, and soda lime silicate glass is included in the glass (i). Soda lime silicate glass is glass which contains, in terms of mol %, 69 to 72% of SiO₂, 0.1 to 2% of Al₂O₃, 11 to 14% of Na₂O, 0 to 1% of K₂O, 4 to 8% of MgO, and 8 to 10% of CaO.

(i) Glass which has a composition containing, in mol %, 50 to 80% of SiO₂, 0.1 to 25% of Al₂O₃, 3 to 30% of Li₂O+Na₂O+K₂O, 2 to 15% of MgO, 0 to 25% of CaO, and 0 to 5% of ZrO₂

(ii) Glass which has a composition containing, in mol %, 50 to 74% of SiO₂, 1 to 10% of Al₂O₃, 6 to 14% of Na₂O, 3 to 11% of K₂O, 2 to 15% of MgO, 0 to 6% of CaO, and 0 to 5% of ZrO₂, wherein a total content of SiO₂ and Al₂O₃ is 75% or less, a total content of Na₂O and K₂O is 12 to 25%, and a total content of MgO and CaO is 7 to 15%

(iii) Glass which has a composition containing, in mol %, 68 to 80% of SiO₂, 4 to 10% of Al₂O₃, 5 to 15% of Na₂O, 0 to 1% of K₂O, 4 to 15% of MgO, and 0 to 1% of ZrO₂

(iv) Glass which has a composition containing, in mol %, 67 to 75% of SiO₂, 0 to 4% of Al₂O₃, 7 to 15% of Na₂O, 1 to 9% of K₂O, 6 to 14% of MgO, and 0 to 1.5% of ZrO₂, wherein a total content of SiO₂ and Al₂O₃ is 71 to 75%, a total content of Na₂O and K₂O is 12 to 20%, and when CaO is contained, the content of CaO is less than 1%

In a method of manufacturing the glass sheet of the present invention, at least one surface of the glass sheet or glass ribbon is subjected to the dealkalization treatment, thereby removing alkaline components, and thus, the surface Na₂O amount in one surface thereof is lower than that in the other surface thereof by 0.2 mass % to 1.2 mass %. Hereinafter, the term “glass sheet” may be used as a generic term indicating the glass sheet and the glass ribbon.

The following methods are exemplified as the dealkalization treatment of the glass: a method of forming a diffusion inhibiting film not containing alkaline components by, for example, a deposition method such as a dip coating method or a CVD method; a method of treating the glass with liquid or gas capable of ion exchange reaction with alkaline components in the glass (JP-T-7-507762); a method of moving ions under an electric field (JP-A-62-230653); a method of bringing silicate glass containing alkaline components into contact with water (H₂O) at 120° C. or higher in a liquid state (JP-A-11-171599), or the like.

As the liquid or gas capable of ion exchange reaction with alkaline components in the glass, examples thereof include gas or liquid containing molecules having fluorine atoms in the structure thereof, gas or liquid of sulfur, its compound or its chloride, gas or liquid of an acid, or gas or liquid of a nitride.

Examples of the gas or liquid containing molecules having fluorine atoms in the structure thereof include hydrogen fluoride (HF), freon (for example, chlorofluorocarbon, fluorocarbon, hydrochlorofluorocarbon, hydrofluorocarbon, halon and the like), hydrofluoric acid, fluorine (simple substance), trifluoroacetic acid, carbon tetrafluoride, silicon tetrafluoride, phosphorus pentafluoride, phosphorus trifluoride, boron trifluoride, nitrogen trifluoride, chlorine trifluoride, and the like.

Examples of the gas or liquid of sulfur, its compound or its chloride include sulfurous acid, sulfuric acid, peroxomonosulfuric acid, thiosulfuric acid, dithionous acid, disulfuric acid, peroxodisulfuric acid, polythionic acid, hydrogen sulfide, sulfur dioxide, and the like. Examples of the acid include hydrochloric acid, carbonic acid, boric acid, lactic acid, and the like. Examples of the nitride include nitric acid, nitric monoxide, nitrogen dioxide, nitrous oxide, and the like. These are not limited to gas or liquid.

Of these, hydrogen fluoride, freon, or hydrofluoric acid is preferred that the viewpoint that reactivity with the glass sheet surface is high. Of these kinds of gas, two or more kinds thereof may be used by mixture. Furthermore, since oxidation power in the float bath is too strong, it is preferable that fluorine (simple substance) is not used.

When liquid is used, for example, the liquid may be supplied to the glass sheet surface by spray coating as the liquid form or the liquid may be vaporized and then supplied to the glass sheet surface. The liquid may be diluted with other kinds of liquid or gas as necessary.

As the examples of the liquid or the gas capable of ion exchange reaction with alkaline components in the glass, examples thereof include gas or liquid other than the gas or liquid described above. The liquid or gas is preferably liquid or gas which does not react, at room temperature, with the liquid or gas capable of ion exchange reaction with alkaline components in the glass.

Examples of the liquid or gas include N₂, air, H₂, O₂, Ne, Xe, CO₂, Ar, He, Kr, and the like, and the liquid or gas is not limited to these kinds of liquid or gas. Of these kinds of gas, two or more kinds thereof may be used as a mixture.

As carrier gas of the gas capable of ion exchange reaction with alkaline components in the glass, inert gas, such as N₂ or argon, is preferably used. As the gas containing molecules having fluorine atoms in the structure thereof, SO₂ may be further included. SO₂ is used when successively producing a glass sheet by a float method or the like, and prevents a conveying roller from being in contact with the glass sheet in an annealing zone, thereby avoiding the occurrence of a flaw in glass. Furthermore, gas which is decomposed at a high temperature may be included.

In the liquid or gas capable of ion exchange reaction with alkaline components in the glass, water vapor or water may be included. Water vapor may be extracted by bubbling heated water with inert gas, such as nitrogen, helium, argon, or carbon dioxide. When a large amount of water vapor is required, a method in which water is fed to a vaporizer and directly vaporized may be used.

As a specific example of the method of forming the glass sheet having a sheet shape from molten glass in the present invention, a float method is exemplified. In the float method, a glass sheet is manufactured using a glass manufacturing apparatus including a melting furnace in which a raw material of glass is melted, a float bath in which molten glass is floated on a molten metal (tin or the like) to form a glass ribbon, and an annealing furnace in which the glass ribbon is annealed.

When glass is formed on a molten metal (tin) bath, the liquid or gas capable of ion exchange reaction with alkaline components in the glass may be supplied to the glass sheet being conveyed on the molten metal bath from the side not in contact with the metal surface, thereby treating the glass sheet surface. In the annealing zone subsequent to the molten metal (tin) bath, the glass sheet is conveyed by roller conveying.

Here, the annealing zone includes not only the inside of the annealing furnace but also a portion where the glass sheet is conveyed from the molten metal (tin) bath to the annealing furnace in the float bath. In the annealing zone, the gas may be supplied from the size not in contact with the molten metal (tin).

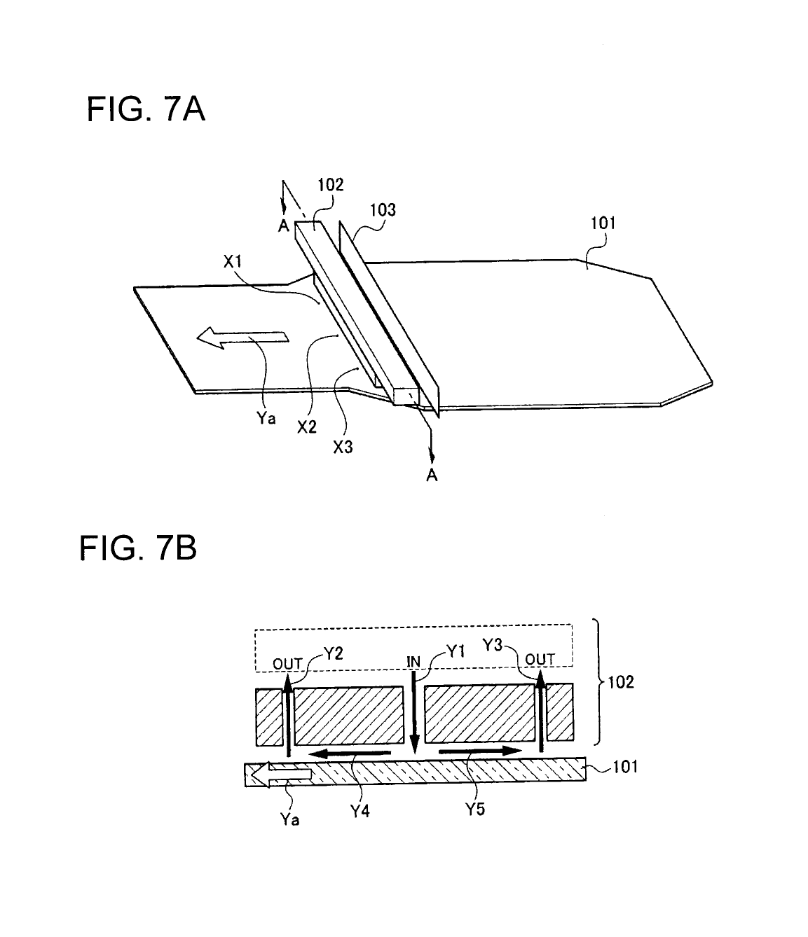

FIG. 7A is a schematic explanatory view of a method of supplying gas containing molecules having fluorine atoms in the structure thereof to treat a glass surface in manufacturing a glass sheet by a float method.

In the float bath in which molten glass is floated on the molten metal (tin or the like) to form a glass ribbon 101, gas containing molecules having fluorine atoms in the structure thereof is sprayed onto the glass ribbon 101 by a beam 102 inserted into the float bath. As shown in FIG. 7A, it is preferable that the gas is sprayed onto the glass ribbon 101 from the side on which the glass ribbon 101 is not in contact with the molten metal surface. An arrow Ya represents a direction in which the glass ribbon 101 flows in the float bath.

It is preferable that the position where the gas is sprayed onto the glass ribbon 101 by the beam 102 is a position where the glass ribbon 101 is preferably 600 to 900° C., more preferably, 700° C. to 900° C., still more preferably 750 to 850° C., and typically 800° C., when a glass transition point thereof is 550° C. or higher. The position of the beam 102 may be on the upstream side or the downstream side of a radiation gate 103. It is preferable that the amount of the gas to be sprayed onto the glass ribbon 101 is 1×10⁻⁶ to 5×10⁴ mol/l cm² of glass ribbon as HF.

FIG. 7B is a sectional view taken along the line A-A of FIG. 7A. The gas sprayed onto the glass ribbon 101 from the direction of Y1 by the beam 102 flows in from “IN” and flows out from the direction of “OUT”. That is, the gas moves in the direction of arrows Y4 and Y5 and is exposed to the glass ribbon 101. Furthermore, the gas which moves in the direction of the arrow Y4 flows out from the direction of an arrow Y2, and the gas which moves in the direction of the arrow Y5 flows out from the direction of an arrow Y3.

The warpage amount of the glass sheet after chemical strengthening may change depending on the position of the glass ribbon 101 in the width direction, and in this case, it is preferable to adjust the amount of the gas. That is, it is preferable that the amount of the gas to be sprayed increases at a position where the warpage amount is large, and the amount of the gas to be sprayed decreases at a position where the warpage amount is small.

When the warpage amount of the glass sheet after chemical strengthening changes depending on the position of the glass ribbon 101, the structure of the beam 102 may be made such that the amount of the gas can be adjusted in the width direction of the glass ribbon 101, thereby adjusting the warpage amount in the width direction of the glass ribbon 101.

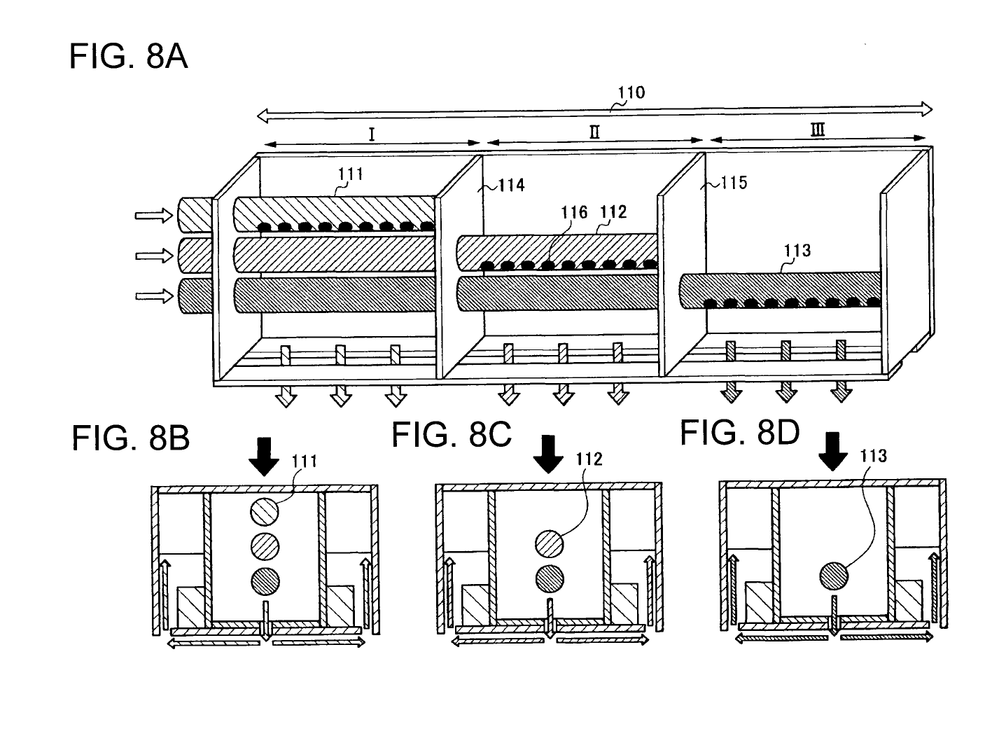

As a specific example thereof FIG. 8A shows a sectional view of the beam 102 which adjusts the amount of the gas while dividing the width direction 110 of the glass ribbon 101 into three systems I to III. Gas systems 111 to 113 are divided by partition walls 114 and 115, and the gas flows out from a gas blowing hole 116 and is sprayed onto glass, respectively.

An arrow in FIG. 8A represents the flow of gas. An arrow in FIG. 8B represents the flow of gas in the gas system 111. An arrow in FIG. 8C represents the flow of gas in the gas system 112. An arrow in FIG. 8D represents the flow of gas in the gas system 113.

As the method of supplying the liquid or gas capable of ion exchange reaction with alkaline components in the glass to the glass surface, for example, a method of using an injector, a method of using an introduction tube, and the like are exemplified.

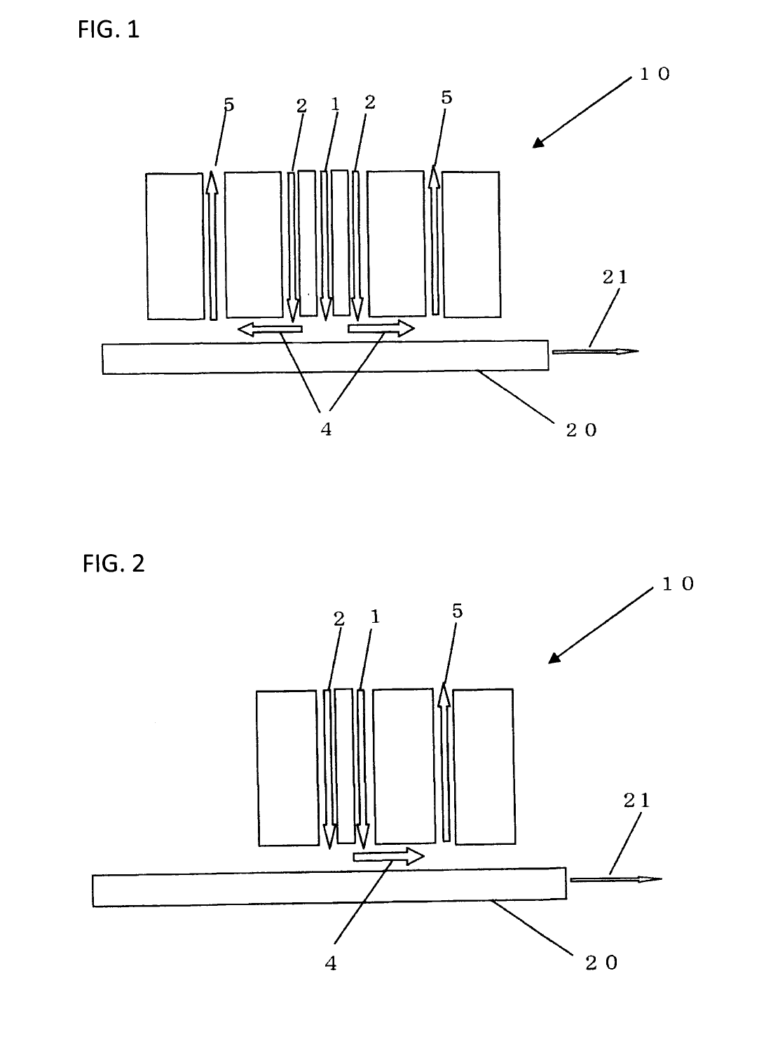

FIGS. 1 and 2 show schematic views of an injector which can be used in the present invention. FIG. 1 is a diagram schematically showing a double-flow type injector. FIG. 2 is a diagram schematically showing a single-flow type injector.

When “the gas or liquid containing molecules having fluorine atoms in the structure thereof” supplied from the injector is gas, it is preferable that the distance between a gas discharge port of the injector and the glass sheet is 50 mm or less.

By setting the distance of 50 mm or less, it is possible to suppress the diffusion of gas into air and to allow a sufficient amount of gas to reach the glass sheet with respect to a desired amount of gas. Conversely, if the distance from the glass sheet is too short, when the treatment of a glass sheet to be produced by a float method is performed online, there is a concern that the glass sheet and the injector are in contact with each other due to fluctuation of the glass ribbon.

When “the liquid or gas capable of ion exchange reaction with alkaline components in the glass” supplied from the injector is liquid, the distance between the liquid discharge port of the injector and the glass sheet is not particularly limited, and an arrangement may be made such that the glass sheet can be treated evenly.

Any type of injector, such as a double-flow type or a single-flow type, may be used, and two or more injectors may be arranged in series in the flow direction of the glass sheet to treat the glass sheet surface. As shown in FIG. 1, the double-flow type injector is an injector in which the flow of gas from discharge to exhaust is split equally in a forward direction and a backward direction with respect to the moving direction of the glass sheet.

As shown in FIG. 2, the single-flow type injector is an injector in which the flow of gas from discharge to exhaust is fixed to either a forward direction or a backward direction with respect to the moving direction of the glass sheet. When the single-flow type injector is used, it is preferable that the flow of gas on/above the glass sheet and the moving direction of the glass sheet are identical in terms of gas flow stability.

It is preferable that a supply port of the liquid or gas capable of ion exchange reaction with alkaline components in the glass and an exhaust port of gas which is generated by a reaction of two or more kinds of gas among unreacted liquid or gas capable of ion exchange reaction with alkaline components in the glass, gas which is generated by a reaction with the glass sheet, and the liquid or gas capable of ion exchange reaction with alkaline components in the glass are present on the same surface of the glass sheet.

When supplying the liquid or gas capable of ion exchange reaction with alkaline components in the glass to the surface of the glass sheet being conveyed to perform dealkalization treatment, for example, in a case where the glass sheet is flowing on a conveyer, the gas or liquid may be supplied from the side not in contact with the conveyer. The gas or liquid may be supplied from the side in contact with the conveyer, by using a mesh material, such as a mesh belt, in which a part of the glass sheet is not covered, in a conveyer belt.

Two or more conveyers may be arranged in series, an injector may be provided between adjacent conveyers, and the gas may be supplied from the side in contact with the conveyer to treat the glass sheet surface. When the glass sheet is flowing on a roller, the gas may be supplied from the side not in contact with the roller or may be supplied from a space between adjacent rollers on the side in contact with the roller.

The same kind or different kinds of gas may be supplied from both sides of the glass sheet. For example, gas may be supplied from both sides of the side not in contact with the roller and the side in contact with the roller to perform dealkalization treatment of the glass sheet. For example, when gas is supplied from both sides in the annealing zone, injectors may be arranged so as to face each other across the glass sheet, and gas may supplied from both sides of the side not in contact with the roller and the side in contact with the roller to glass being successively conveyed.

The injector arranged on the side in contact with the roller and the injector arranged on the side not in contact with the roller may be arranged at different positions in the flow direction of the glass sheet. When arranging the injectors at different positions, any of the injector may be arranged on the upstream side or the downstream side with respect to the flow direction of the glass sheet.

It is widely known that a glass sheet with a transparent conductive film is manufactured online in combination of a glass manufacturing technique by a float method and a CVD technique. In this case, it is known that, in regard to a transparent conductive film and its base film, gas is supplied from the surface not in contact with tin or from the surface not in contact with the roller to form a film on the glass sheet.

For example, in the manufacture of the glass sheet with a transparent conductive film by online CVD, an injector may be arranged on the surface in contact with the roller, and the liquid or gas capable of ion exchange reaction with alkaline components in the glass may be supplied from the injector to the glass sheet to treat the glass sheet surface.

In the present invention, in regard to the temperature of the glass sheet when the liquid or gas capable of ion exchange reaction with alkaline components in the glass is supplied to the surface of the glass sheet being conveyed to treat the surface, in a case where the glass transition temperature of the glass sheet is Tg, the surface temperature of the glass sheet is preferably (Tg−200° C.) to (Tg+300° C.), and more preferably (Tg−200° C.) to (Tg+250° C.). Regardless of the above, the surface temperature of the glass sheet is preferably more than 650° C. as long as the surface temperature thereof is equal to or less than (Tg+300° C.). As described in examples described below, if dealkalization is performed at the surface temperature of the glass sheet of 650° C. or lower, a recess is likely to be generated.

The pressure of the glass sheet surface when supplying the liquid or gas capable of ion exchange reaction with alkaline components in the glass to the glass sheet surface is preferably in an atmosphere within a pressure range of (atmospheric pressure−100 pascals) to (atmospheric pressure+100 pascals), and more preferably, in an atmosphere within a pressure range of (atmospheric pressure−50 pascals) to (atmospheric pressure+50 pascals).

In regard to the gas flow rate, for example, the case where HF is used as the liquid or gas capable of ion exchange reaction with alkaline components in the glass will be described as a representative example. When performing the treatment of the glass sheet with HF, preferably, the higher the HF flow rate is, the greater the warpage improvement effect during chemical strengthening treatment is, and when the total gas flow is identical, the higher the HF concentration is, the greater the warpage improvement effect during chemical strengthening treatment is.

When the total gas flow and the HF gas flow rate are identical, the longer the treatment time of the glass sheet is, the greater the warpage improvement effect during chemical strengthening treatment is. For example, when the glass sheet is heated, and the gas sheet surface is then treated using the liquid or gas capable of ion exchange reaction with alkaline components in the glass, as the conveying speed of the glass sheet is low, the warpage after chemical strengthening is improved. Even in an equipment which cannot control the total gas flow rate or the HF flow rate successfully, the conveying speed of the glass sheet is appropriately controlled, thereby improving the warpage after chemical strengthening.

FIG. 6 is a schematic view of a method of supplying gas capable of ion exchange reaction with alkaline components in the glass to a glass sheet using an introduction tube. As the method of supplying gas capable of ion exchange reaction with alkaline components in the glass to the glass sheet using the introduction tube, specifically, for example, a sample 63 of a glass sheet placed on a sample loading carriage 62 is moved into a reaction vessel 61 provided at the center of a tube furnace 60 heated to a treatment temperature in advance by moving a slider 64.

Next, after temperature equalization treatment is performed for, preferably, 60 to 180 seconds, gas capable of ion exchange reaction with alkaline components in the glass is introduced from the introduction tube 65 in an introduction direction 67 and retained, and is exhausted from an exhaust direction 68. After the retention time ends, the sample 63 undergoes annealing conditions (for example, retention for one minute at 500° C. and retention for one minute at 400° C.), and the sample is extracted by a sample extracting rod 66.

The concentration of gas capable of ion exchange reaction with alkaline components in the glass introduced from the introduction tube 65 to the glass sheet is preferably 0.01 to 1%, and more preferably 0.05 to 0.5%. The retention time after the introduction of the gas is preferably 10 to 600 seconds, and more preferably 30 to 300 seconds.

3. Chemical Strengthening

Chemical strengthening is treatment in which alkali metal ions (typically, Li ions or Na ions) having a smaller ion radius in a glass surface are exchanged with alkali ions (typically, K ions) having a larger ion radius by ion exchange at a temperature equal to or lower than a glass transition temperature to thereby form a compressive stress layer in the glass surface. The chemical strengthening treatment may be performed by a conventional method in the related art.

The chemically strengthened glass sheet of the present invention is a glass sheet in which the warpage after chemical strengthening is improved. The amount of change (the amount of warpage change) in warpage of the glass sheet after chemical strengthening with respect to the glass sheet before chemical strengthening can be measured by a three-dimensional shape measurement instrument (for example, manufactured by MITAKA KOHKI Co., Ltd.).

In the present invention, the improvement of warpage after chemical strengthening is evaluated by the warpage improvement rate determined by the following expression in an experiment under the same conditions except that dealkalization treatment is performed by the liquid or gas capable of ion exchange reaction with alkaline components in the glass.

Warpage improvement rate(%)=[1−(ΔY/ΔX)]×100

ΔX: amount of warpage change by chemical strengthening of untreated glass sheet

ΔY: amount of warpage amount by chemical strengthening of treated glass sheet

Here, the amount of warpage change is set to ΔX>0. With regard to ΔY, in the case of being warped in the same direction with ΔX, the relation of ΔY>0 is satisfied, and in the case of being warped in the direction opposite to ΔX, the relation of ΔY<0 is satisfied.

In the glass sheet which has not been subjected to the dealkalization treatment with the liquid or gas capable of ion exchange reaction with alkaline components in the glass, the relation of ΔX=ΔY is satisfied, and the warpage improvement rate is 0%. When ΔY indicates a negative value, the relation of warpage improvement rate >100% is satisfied.

CS and DOL of the glass sheet can be measured by a surface stress meter. The surface compressive stress of the chemically strengthened glass is preferably 600 MPa or more, and the depth of the compressive stress layer is preferably 15 μm or more. The surface compressive stress of the chemically strengthened glass and the depth of the compressive stress layer are set within an appropriate range, whereby excellent strength and scratch resistance are obtained.

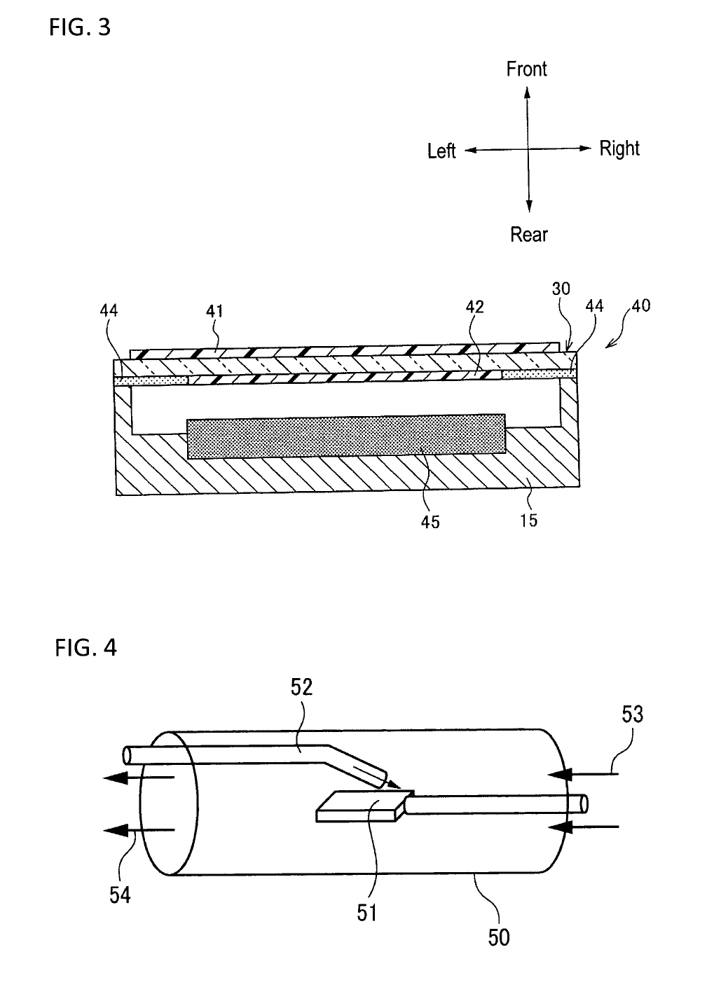

Hereinafter, an example where the glass sheet of the present invention which has been chemically strengthened is used as a cover glass for a flat panel display will be described. FIG. 3 is a sectional view of a display device in which a cover glass is arranged. In the following description, the front, the rear, the left, and the right are based on the directions of arrows in the figures.

As shown in FIG. 2, a display device 40 includes a display panel 45 which is provided in a housing 15, and a cover glass 30 which is provided so as to cover the entire surface of the display panel 45 and to surround the front of the housing 15.

The cover glass 30 is primarily provided for the purpose of improving beauty or strength of the display device 40 or preventing damage caused by impact, and is formed of single sheet-shaped glass having an entire shape of a substantially planar shape. As shown in FIG. 2, the cover glass 30 may be arranged so as to be separated from the display side (front side) of the display panel 45 (to have an air layer) or may be attached to the display side of the display panel 45 through a light transmissive adhesive film (not shown).

A functional film 41 is provided on the front surface of the cover glass 30 on which light from the display panel 45 is emitted, and a functional film 42 is provided on the rear surface, on which light from the display panel 45 is incident, at a position corresponding to the display panel 45. In FIG. 2, although the functional films 41 and 42 are provided on both surfaces, the present invention is not limited thereto, and the functional films 41 and 42 may be provided on the front surface or the rear surfaces or may be omitted.

The functional films 41 and 42 have functions of, for example, preventing reflection of ambient light, preventing damage caused by impact, shielding electromagnetic waves, shielding near infrared rays, correcting color tone, and/or improving scratch resistance, and the thickness, the shape and the like thereof are appropriately selected depending on use applications. For example, the functional films 41 and 42 are formed by attaching a resin-made film to the cover glass 30. Alternatively, the functional films 41 and 42 may be formed by a thin film forming method, such as a vapor deposition method, a sputtering method, or a CVD method.

Reference numeral 44 is a black layer, and for example, is coating formed by coating ink containing a pigment particle on the cover glass 30 and performing ultraviolet irradiation or heating and burning, and then cooling. Thanks to the black layer, the display panel or the like is not viewed from the outside of the housing 15, and the esthetics of the appearance is improved.

### EXAMPLES

Hereinafter, examples of the present invention will be specifically described. However, the present invention is not limited to the examples.

### (Composition of Glass Sheet)

In this example, glass sheets of glass materials A to C having the following compositions were used. The glass material D having the following composition can be used in the present invention.

(Glass material A) Glass containing, in mol %, 72.0% of SiO₂, 1.1% of Al₂O₃, 12.6% of Na₂O, 0.2% of K₂O, 5.5% of MgO, and 8.6% of CaO (glass transition temperature: 566° C.)

(Glass material B) Glass containing, in mol %, 64.3% of SiO₂, 6.0% of Al₂O₃, 12.0% of Na₂O, 4.0% of K₂O, 11.0% of MgO, 0.1% of CaO, 0.1% of SrO, 0.1% of BaO, and 2.5% of ZrO₂ (glass transition temperature: 620° C.)

(Glass material C) Glass containing, in mol %, 64.3% of SiO₂, 8.0% of Al₂O₃, 12.5% of Na₂O, 4.0% of K₂O, 10.5% of MgO, 0.1% of CaO, 0.1% of SrO, 0.1% of BaO, and 0.5% of ZrO₂ (glass transition temperature: 604° C.)

(Glass material D) Glass containing, in mol %, 73.0% of SiO₂, 7.0% of Al₂O₃, 14.0% of Na₂O, and 6.0% of MgO (glass transition temperature: 617° C.)

### (Measurement of Warpage Amount)

The warpage amount was measured by a three-dimensional shape measurement instrument (NH-3MA) manufactured by MITAKA KOHKI Co., Ltd. before chemical strengthening, and then, the respective glass was subjected to chemical strengthening, and the warpage amount after chemical strengthening was measured in the same manner, and Δ warpage amount expressed by the following expression was calculated.

ΔWarpage amount=warpage amount after chemical strengthening−warpage amount before chemical strengthening

### (Warpage Improvement Rate)

The improvement of warpage after chemical strengthening was evaluated by the warpage improvement rate by the following expression in an experiment under the same conditions except that dealkalization treatment was performed by the liquid or gas capable of ion exchange reaction with alkaline components in the glass.

Warpage improvement rate(%)=[1−(ΔY/ΔX)]×100

ΔX: amount of warpage change by chemical strengthening of untreated glass sheet

ΔY: amount of warpage amount by chemical strengthening of treated glass sheet

Here, the amount of warpage change was set to ΔX>0. With regard to ΔY, in the case of being warped in the same direction with ΔX, the relation of ΔY>0 was satisfied, and in the case of being warped in the direction opposite to ΔX, the relation of ΔY<0 was satisfied.

(XRF Analysis)

The analysis conditions of the X-ray fluorescence (XRF) analysis was as follows. The amount of Na₂O was determined by using the calibration curve method and a reference sample of Na₂O.

Measurement apparatus: ZSX100 manufactured by Rigaku Corporation.

Output: Rh 50 kV-72 mA

Filter: OUT

Attenuator: 1/1

Slit: Std.

Analyzing crystal: RX25

Detector: PC

Peak angle (2θ/deg.): 47.05

Peak measurement time period (seconds): 40

B. G. 1 (2θ/deg.): 43.00

B. G. 1 measurement time period (seconds): 20

B. G. 2 (2θ/deg.): 50.00

B. G. 2 measurement time period (seconds): 20

PHA: 110-450

### Example 1

As in the schematic view in FIG. 4, glass was made of the glass material A and glass material C by using the float method, the glass was put in a quartz tube 50 having a volume of 3.2 L, and the tube was vacuumized. Thereafter, a system was filled with a mixed gas of 10% of H₂ and 90% of N₂ so as to simulate an atmosphere in a float bath. The temperature of the glass sheet 51 was increased by heating for 3 minutes while introducing the mixed gas of 10% of H₂ and 90% of N₂ into the entire system at a flow rate of 1.6 L/min. The mixed gas of 10% of H₂ and 90% of N₂ was introduced from a gas introduction direction 53, and discharged in a gas discharge direction 54.

While the glass sheet 51 having an elevated temperature was heated for 30 seconds at a temperature of 712° C. for the case of the glass material A, and at a temperature of 800° C. for the case of the glass material C, HF or freon having the concentration shown in Table 1 was sprayed on the glass sheet 51 at a flow rate of 0.4 L/min via a gas introduction nozzle 52 having an inner diameter of 3.5 mm to 4.0 mm. Thereafter, while the mixed gas of 10% of H₂ and 90% of N₂ was introduced at a flow rate of 1.6 L/min, the temperature of the glass sheet was decreased for 20 minutes.

The obtained glass sheet which had been subjected to dealkalization treatment with the obtained HF or freon was subject to chemical strengthening with potassium nitrate molten salt at a temperature of 435° C. for 4 hours, and then, the following was measured: Δ warpage amount (the amount of warpage change); the warpage improvement rate; the surface Na₂O amount in one surface thereof measured by the XRF analysis; the surface Na₂O amount in the other surface thereof; and its difference (mass %; the ΔNa₂O) therebetween. The measurement results are shown in Table 1. The Δ warpage amounts of untreated glass sheet of the glass materials A and C by chemical strengthening are 29.2 μm and 23.0 μm, respectively.

Table 5 shows a relationship between the ΔNa₂O amount and the Δ warpage improvement rate after chemical strengthening. Furthermore, in Example 1-2 and Example 1-4, each surface treated with the HF or freon was subjected to an etching process, and the average amounts of Na₂O at depths of 5 μm to 6 μm and 100 μm to 101 μm from each of the treated surfaces were measured. Table 1 shows the measurement results. Since each of these examples shows that the average amounts of Na₂O at depths of 5 μm to 6 μm from the treated surfaces and the average amounts of Na₂O 100 μm to 101 μm from the treated surfaces are the same, it could be found that the region where the dealkalization treatment was conducted is a region of the range from the treated surface to a depth of 5 μm or less.

TABLE 1

| | | | | Comparative | | |
|---|---|---|---|---|---|---|
| | | Example 1-1 | Example 1-2 | Example 1-1 | Example 1-3 | Example 1-4 |
| Glass material | | A | A | A | C | C |
| Surface treatment | | HF-400 ppm | HF-800 ppm | N₂-100% | HF-400 ppm | HF-800 ppm |
| Treatment temperature | | 712° C. | 712° C. | 712° C. | 800° C. | 800° C. |
| Warpage amount | Before chemical | 45.6 | 45.0 | 37.7 | 30.3 | 35.3 |
| | strengthening | | | | | |
| | After chemical | 64.4 | 57.9 | 66.8 | 17.7 | 19.0 |
| | strengthening | | | | | |

| | | | | | |
|---|---|---|---|---|---|
| Δ Warpage amount (μm) | 18.8 | 12.9 | 29.2 | −2.6 | −16.3 |
| Warpage Rate (%) | 64.4% | 44.2% | 100.0% | −54.7% | −70.6% |
| Warpage improvement rate (%) | 35.6% | 55.8% | 0.0% | 154.7% | 170.6% |
| Average amount of Na₂O (mass %) at | 12.3% | 12.1% | 12.5% | 12.0% | 11.8% |
| 0 μm to 1 μm from treated surface | | | | | |
| Average amount of Na₂O (mass %) at | — | 12.6% | — | — | 12.5% |
| 5 μm to 6 μm from treated surface | | | | | |
| Average amount of Na₂O (mass %) at | — | 12.6% | — | — | 12.5% |
| 100 μm to 101 μm from treated surface | | | | | |
| Average amount of Na₂O (mass %) at | 12.6% | 12.6% | 12.6% | 12.5% | 12.5% |
| 0 μm to 1 μm from untreated surface | | | | | |
| Δ Na₂O amount (mass %) | 0.3% | 0.5% | 0.1% | 0.5% | 0.7% |

| | | | | | Comparative |
|---|---|---|---|---|---|
| | | Example 1-5 | Example 1-6 | Example 1-7 | Example 1-2 |
| Glass material | | C | C | C | C |
| Surface treatment | | Freon-400 ppm | Freon-800 ppm | Freon-5000 ppm | N₂-100% |
| Treatment temperature | | 800° C. | 800° C. | 800° C. | 800° C. |
| Warpage amount | Before chemical | 37.0 | 30.0 | 28.3 | 23.3 |
| | strengthening | | | | |
| | After chemical | 34.0 | 24.3 | −13.3 | 46.3 |
| | strengthening | | | | |

| | | | | |
|---|---|---|---|---|
| Δ Warpage amount (μm) | −3.0 | −5.7 | −41.6 | 23.0 |
| Warpage Rate (%) | −13.0% | −24.6% | −180.6% | 100.0% |
| Warpage improvement rate (%) | 113.0% | 124.6% | 280.6% | 0.00% |
| Average amount of Na₂O (mass %) at | 11.8% | 11.8% | 11.8% | 12.4% |
| 0 μm to 1 μm from treated surface | | | | |
| Average amount of Na₂O (mass %) at | — | — | — | 12.5% |
| 5 μm to 6 μm from treated surface | | | | |
| Average amount of Na₂O (mass %) at | — | — | — | 12.5% |
| 100 μm to 101 μm from treated surface | | | | |
| Average amount of Na₂O (mass %) at | 12.5% | 12.5% | 12.5% | 12.5% |
| 0 μm to 1 μm from untreated surface | | | | |
| Δ Na₂O amount (mass %) | 0.7% | 0.7% | 0.7% | 0.1% |

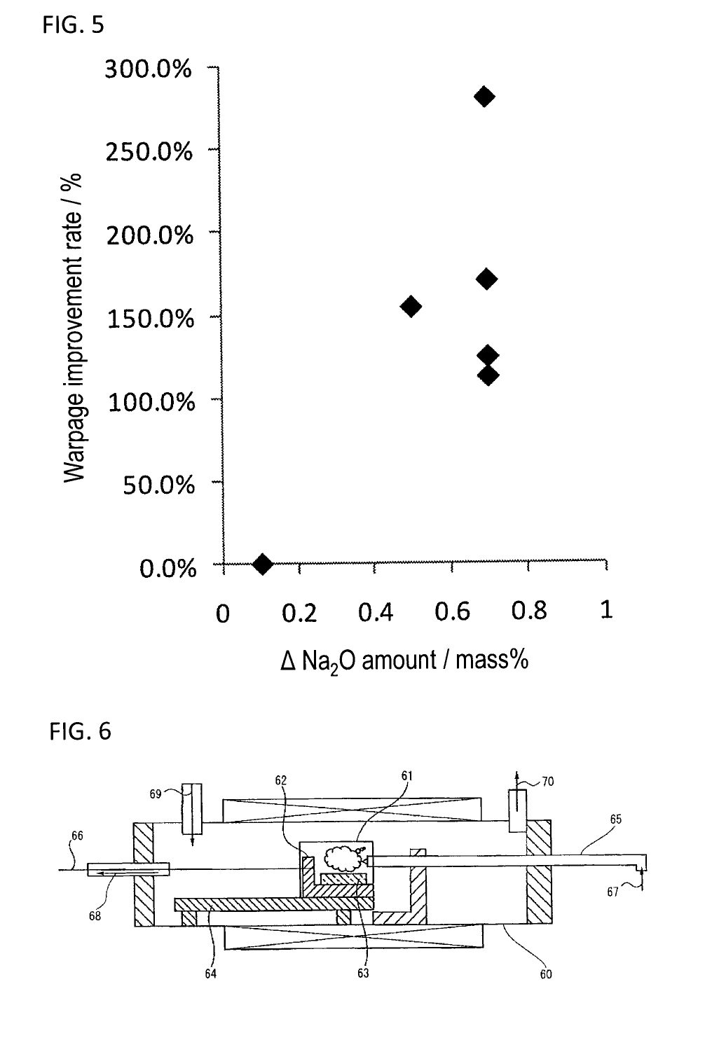

As shown in Table 1 and FIG. 5, it could be found that when the fluorine concentration in one surface was increased by the HF or freon treatment of the surfaces, followed by subjected to the chemical strengthening, an improvement in warpage of the chemically strengthened glass sheet was achieved.

### Example 2

In the float bath where the glass ribbon made of the glass material C flowed, the HF treatment was conducted.

The obtained glass having a sheet thickness of 0.7 mm was cut into three sheets of 100 mm square, warpage of two diagonal lines of a portion corresponding to a 90 mm square portion of the substrate was measured, and the average value was set as a warpage amount before strengthening. The following was measured: the surface Na₂O amount in one surface of the glass measured by the XRF analysis; the surface Na₂O amount in the other surface thereof; and the difference (mass %; the ΔNa₂O amount) therebetween. Thereafter, each of the glass substrates was immersed in KNO₃ molten salt heated to 435° C. for four hours, and thus underwent the chemical strengthening. Thereafter, glass was immersed in KNO₃ molten salt heated to 435° C., for 4 hours, thereby performing chemical strengthening. Next, the warpage of the two diagonal lines of the portion corresponding to the 90 mm square portion of the substrate was measured, and the average value was set as a warpage amount after strengthening.

Table 2 shows the results. Comparative Example 2-1 is a reference example where the HF treatment was not conducted. The average amount of Na₂O in an untreated surface in the case of Example 2-6, having the maximum HF total contact amount and having been expected to be the most affected by the HF treatment, is not different to one decimal place from of the average amount of Na₂O in an untreated surface of the case of Comparative example 2-1 which is a reference example where the HF treatment was not conducted. Taking this fact into consideration, it is considered that, in the embodiment of the HF treatment in the present examples, the untreated surface is not subjected to the dealkalization treatment, and the average amount of Na₂O in the untreated surface at a depth of 0 to 1 μm is not changed by the HF treatment. With regard to the sample in which the average amount of Na₂O in the untreated surface at a depth of 0 to 1 μm was not measured, the ΔNa₂O was calculated on the assumption that the average amount of Na₂O was considered to be 12.04 (the average of the two values described above).

Furthermore, the respective HF-treated surfaces of the glass sheets in examples and comparison examples were observed by using SEM at a magnification of 50,000, and as a result, the recesses were observed on the respective surfaces only in Examples 2-5, 2-6 and 2-7. The density of the recesses on the surface of each of the glass sheets obtained from each observed SEM image was estimated, and as a result, the density was 5 recesses/μm² in Example 2-5, 13 recesses/μm² in Example 2-6, and 172 recesses/μm² in Example 2-7.

TABLE 2

| | | | | | | | | XRF analysis result | | |
|---|---|---|---|---|---|---|---|---|---|---|
| | | | | | | | | Average | Average | |
| | | | | | | | | amount | amount | |
| | | | | | | | | of | of | |
| | | | | | | | | Na₂O at | Na₂O at | |
| | HF treatment | | | | | | | 0 μm to | 0 μm to | |
| | | HF total | | | Warpage [μm] | | | 1 μm from | 1 μm from | |
| | Treatment | contact | Surface stress | | Before | After | Δ | treated | untreated | Δ Na₂O |
| | temperature | amount | CS | DOL | chemical | chemical | Warpage | surface | surface | amount |
| | [° C.] | [mol/cm²] | (MPa) | (μm) | strengthening | strengthening | amount | [mass %] | [mass %] | [mass %] |
| Example 2-1 | 757 | 4.82E−05 | 791.4 | 46.2 | 12.8 | 75.3 | 62.5 | 11.83 | — | 0.21 |
| Example 2-2 | 757 | 6.39E−05 | 757.5 | 49.2 | 10.8 | 67.4 | 56.6 | 11.80 | — | 0.24 |
| Example 2-3 | 757 | 9.58E−05 | 789.3 | 48.4 | 8.0 | 22.4 | 14.4 | 11.77 | — | 0.27 |
| Example 2-4 | 757 | 1.28E−04 | 764.7 | 47.6 | 5.0 | 39.1 | 34.1 | 11.79 | — | 0.25 |
| Example 2-5 | 757 | 1.44E−04 | 779.9 | 48.2 | 10.6 | −12.1 | −22.7 | 11.75 | — | 0.29 |
| Example 2-6 | 757 | 2.55E−04 | 755.3 | 47.7 | 3.3 | −85.5 | −88.8 | 11.75 | 12.06 | 0.31 |
| Example 2-7 | 627 | 1.05E−04 | 786.9 | 47.8 | 8.5 | 125.5 | 117.0 | 11.67 | — | 0.37 |
| Comparative | — | 0.00E+00 | 775.3 | 47.3 | 13.2 | 173.2 | 160.0 | 12.02 | 12.02 | 0.00 |
| Example 2-1 | | | | | | | | | | |
| Comparative | 757 | 1.28E−05 | 768.5 | 46.9 | 10.4 | 122.9 | 112.5 | 11.92 | — | 0.12 |
| Example 2-2 | | | | | | | | | | |

As shown in Table 2, in the glass sheet of each Example, in which the ΔNa₂O amount obtained from the amounts of Na₂O in both surfaces was 0.2 mass % or more, the Δ warpage amount was smaller, and an improvement in warpage of the chemically strengthened glass sheet was obtained, as compared to the glass sheet of each comparison example, in which the ΔNa₂O amount difference was 0.2 mass % or less.

### Reference Example

When the float glass made of soda lime silica glass was heated to 500° C., and a mixture of air pre-heated to 100° C. and 5 vol. % of HF gas was sprayed to a top surface of the float glass at a flow rate of 52 L/min for 3 minutes, the difference in ΔNa₂O amount between the top surface and a bottom surface was 1 mass %. When the top surface was observed by using SEM, a plurality of the recesses were found, and a density of the recesses was 172 recesses/μm² or more.

Although the present invention has been described in detail using specific embodiments, it is obvious to those skilled in the art that various alterations and modifications may be made without departing from the spirit and scope of the present invention. This application is based on Japanese Patent application No. 2012-069557 filed on Mar. 26, 2012, Japanese Patent application No. 2012-078171 filed on Mar. 29, 2012, Japanese Patent Application No. 2012-081072 filed on Mar. 30, 2012, Japanese Patent Application No. 2012-081073 filed on Mar. 30, 2012, and Japanese Patent Application No. 2012-276840 filed on Dec. 19, 2012, the contents of which are incorporated herein by reference.

### REFERENCE SIGNS LIST

1: Center slit
2: Outer slit
4: Channel
5: Discharge slit
20: Glass sheet
30: Cover glass
40: Display device
41, 42: Functional film
15: Housing
45: Display panel
50: Quartz tube
51: Glass sheet
52: Gas introduction nozzle
60: Tube furnace
61: Reaction vessel
62: Sample loading carriage
63: Sample
64: Slider
65: Introduction tube
66: Sample extracting rod
101: Glass ribbon
102: Beam
103: Radiation gate
110: Width direction of glass ribbon
111, 112, 113: Gas system
114, 115: Partition wall
116: Gas blowing hole

1. A glass sheet, which is obtained by chemically strengthening a glass sheet before chemical strengthening which does not comprise CaO or comprises 6 mol % or less of CaO, wherein a surface Na₂O amount in one surface thereof is lower than the surface Na₂O amount in the other surface thereof by 0.2 mass % to 1.2 mass % in the glass sheet before chemical strengthening.

2. A glass sheet, which is obtained by chemically strengthening a glass sheet before chemical strengthening comprising 4 mol % or more of Al₂O₃, wherein a surface Na₂O amount in one surface thereof is lower than the surface Na₂O amount in the other surface thereof by 0.2 mass % to 1.2 mass % in the glass sheet before chemical strengthening.

3. The glass sheet according to claim 1, wherein the surface Na₂O amount in the one surface is lower than the surface Na₂O amount in the other surface by 0.7 mass % in the glass sheet before chemical strengthening.

4. The glass sheet according to claim 1, wherein the glass sheet before chemical strengthening is manufactured by a float method.

5. The glass sheet according to claim 1, wherein the surface having the smaller surface Na₂O amount is a surface which has not been in contact with molten metal in a float bath in the glass sheet before chemical strengthening.

6. The glass sheet according to claim 1, wherein in the surface having the smaller surface Na₂O amount, a layer having an amount of Na₂O lower than the amount of Na₂O inside the glass sheet has a thickness of less than 5 μm in the glass sheet before chemical strengthening.

7. The glass sheet according to claim 1, wherein the glass sheet before chemical strengthening has a thickness of 1.5 mm or less.

8. The glass sheet according to claim 1, wherein the glass sheet before chemical strengthening has a thickness of 0.8 mm or less.

9. A chemically strengthened glass sheet, wherein a surface Na₂O amount in one surface thereof is lower than the surface Na₂O amount in the other surface thereof by 0.2 mass % to 1.2 mass %.

10. The chemically strengthened glass sheet according to claim 9, wherein in the surface having the smaller surface Na₂O amount, a layer having an amount of Na₂O lower than the amount of Na₂O inside the glass sheet has a thickness of less than 5 μm.

11. The chemically strengthened glass sheet according to claim 9, which has a thickness of 1.5 mm or less.

12. The chemically strengthened glass sheet according to claim 9, which has a thickness of 0.8 mm or less.
